(19) United States
(12) Patent Application Publication
(10) Pub. No.: US 2015/0222117 A1
(43) Pub. Date: Aug. 6, 2015

(54) BATTERY TRAY, BATTERY RACK, ENERGY SYSTEM, AND METHOD OF OPERATING THE BATTERY TRAY

(71) Applicant: SAMSUNG SDI CO., LTD., Yongin-si (KR)

(72) Inventor: Jae-Sung IM, Yongin-si (KR)

(21) Appl. No.: 14/561,687

(22) Filed: Dec. 5, 2014

(30) Foreign Application Priority Data
Feb. 4, 2014 (KR) 10-2014-0012679

(51) Int. Cl. H02J 1/06

(52) U.S. Cl. CPC H02J 1/06

(57) ABSTRACT

A battery tray, a battery rack, an energy storage system, and a method of operating the battery tray are disclosed. The battery tray includes a pair of terminals including a first tray terminal, a battery including at least one battery cell; and a main switch including a first node electrically connected to the battery and a second node electrically connected to the first tray terminal. A main controller manages the battery and controls the main switch. A driving voltage control unit detects a battery voltage of the first node and terminal voltage of the second node, and controls operation of the main controller based on the battery voltage and the terminal voltage.

### CROSS-REFERENCE TO RELATED APPLICATION

Korean Patent Application No. 10-2014-0012679, filed on Feb. 4, 2014, and entitled, “Battery Tray, Battery Rack, Energy System, and Method of Operating the Battery Tray,” is incorporated by reference herein in its entirety.

### BACKGROUND

1. Field

One or more embodiments described herein relate to a battery tray, a battery rack, an energy system, and a method of operating the battery tray. .

2. Description of the Related Art

The demand for energy storage systems is increasing as smart grids and new renewable energy become popular and as efficiency and stability of electric grids is emphasized. An energy storage system stores surplus power when power demand is low and provides the stored power when power demand is high. These systems may operate as power supplies, may include demand control, and may improve power quality. In order to meet the ever-increasing demand, efforts are being made to increase the power storage capacity of energy storage systems.

One approach for increasing capacity involves connecting battery trays in parallel. If voltages of the battery trays are different, an in-rush current is formed when the trays are connected. The in-rush current may damage the battery cells in the trays and their attendant protection circuits.

### SUMMARY

In accordance with one embodiment, a battery tray including a pair of tray terminals including a first tray terminal; a battery including at least one battery cell; a main switch including a first node electrically connected to the battery and a second node electrically connected to the first tray terminal; a main controller to manage the battery and control the main switch; and a driving voltage control unit to detect a battery voltage of the first node and terminal voltage of the second node, and to control operation of the main controller based on the battery voltage and the terminal voltage.

The battery tray may include a driving voltage switch electrically connected between a driving voltage terminal to which a driving voltage is applied and the main controller, wherein the driving voltage control unit may control the driving voltage switch based on the battery voltage and the terminal voltage.

The driving voltage control unit may include a battery voltage detecting unit to detect the battery voltage and to output a battery voltage signal corresponding to the battery voltage; a terminal voltage detecting unit to detect the terminal voltage and to output a terminal voltage signal corresponding to the terminal voltage; and an auxiliary controller to receive the battery voltage signal and the terminal voltage signal, and to output a driving voltage control signal for controlling the driving voltage switch.

The battery voltage detecting unit may include a first voltage divider circuit which is electrically connected to the first node and which outputs the battery voltage signal, and the terminal voltage detecting unit including a second voltage divider circuit which is electrically connected to the second node and which outputs the terminal voltage signal. The auxiliary controller may consume less power than the main controller. The auxiliary controller may be driven based on the driving voltage.

The driving voltage control unit may turn on the driving voltage switch to apply the driving voltage to the main controller, when a difference between the battery voltage and terminal voltage is less than or equal to a preset critical voltage. The critical voltage may be a value between 0.5V and 2V or may be a value between 0.5% to 2% of the battery voltage.

The driving voltage control unit may determine whether the first tray terminal may be in a floating state, and when the first tray terminal is determined to be in a floating state, the driving voltage control unit may turn on the driving voltage switch to apply the driving voltage to the main controller, regardless of the battery voltage and the terminal voltage.

The battery tray may include a setup unit to set deactivation of the driving voltage control unit, wherein, when the driving voltage control unit is set to be deactivated by the setup unit, the main controller is to receive the driving voltage regardless of the battery voltage and the terminal voltage.

In accordance with another embodiment, a battery rack includes a plurality of battery trays connected in parallel; and a rack management unit to manage the plurality of battery trays, wherein each of the battery trays includes: a pair of tray terminals including a first tray terminal; a battery including at least one battery cell; a main switch including a first node electrically connected to the battery and a second node electrically connected to the first tray terminal; a main controller to manage the battery and control the main switch; and a driving voltage control unit to detect a battery voltage of the first node and a terminal voltage of the second node, and to control operation of the main controller based on the battery voltage and the terminal voltage. At least one of the batteries of the plurality of battery trays may serve as a driving power supply of the rack management unit.

Each of the battery trays may include a driving voltage switch electrically connected between a driving voltage terminal to which a driving voltage is applied and the main controller, wherein the driving voltage control unit is to control the driving voltage switch based on the battery voltage and the terminal voltage.

The driving voltage control unit may turn on the driving voltage switch to apply the driving voltage to the main controller when a difference between the battery voltage and terminal voltage is less than or equal to a preset critical voltage, and the driving voltage control unit may turn off the driving voltage switch to prevent the driving voltage from being applied to the main controller when a difference between the battery voltage and terminal voltage is greater than the preset critical voltage.

The battery trays may include a first battery tray having a turned-on main switch and a second battery tray having a turned-off main switch. When a difference between battery voltage of the first battery tray and the battery voltage of the second battery tray is less than or equal to the critical voltage, the driving voltage control unit of the second battery tray may turn on the driving voltage switch of the second battery tray to apply the driving voltage to the main controller of the second battery tray. When the difference between battery voltage of the first battery tray and battery voltage of the second battery tray is greater than the critical voltage, the driving voltage control unit of the second battery tray may turn on the driving voltage switch of the second battery tray to apply the driving voltage to the main controller of the second battery tray.

The driving voltage control unit may include a battery voltage detecting unit to detect the battery voltage and to output a battery voltage signal corresponding to the battery voltage; a terminal voltage detecting unit to detect the terminal voltage and to output a terminal voltage signal corresponding to the terminal voltage; and an auxiliary controller to receive the battery voltage signal and the terminal voltage signal and to output a driving voltage control signal for controlling the driving voltage switch.

In accordance with another embodiment, an energy storage system includes a battery system including a battery rack as described above, a power conversion system including: a power conversion apparatus to convert power between or among at least two of a power generating system, a grid, a load, or the battery system, and an integrated controller to control the power conversion apparatus.

In accordance with another embodiment, a method of operating a battery tray includes detecting a first voltage of a first node of a main switch via a driving voltage control unit; detecting a second voltage of a second node of the main switch via the driving voltage control unit; and driving a main controller based on the first voltage and second voltage via the driving voltage control unit.

Driving the main controller may include comparing a difference between the first voltage and second voltage to a preset critical voltage; when the difference is less than or equal to the critical voltage, driving the main controller; and when the difference is greater than the critical voltage, preventing driving of the main controller.

The battery tray may include a driving voltage switch to provide a driving voltage to the main controller, and driving the main controller may include controlling the driving voltage switch based on the first voltage and the second voltage via the driving voltage control unit.

### BRIEF DESCRIPTION OF THE DRAWINGS

Features will become apparent to those of skill in the art by describing in detail exemplary embodiments with reference to the attached drawings in which:

FIG. 1 illustrates an embodiment of a battery tray;

FIG. 2 illustrates another embodiment of a battery tray;

FIG. 3 illustrates another embodiment of a battery tray;

FIG. 4 illustrates an embodiment of a battery rack;

FIG. 5 illustrates an embodiment of an energy storage system; and

FIG. 6 illustrates a more detailed embodiment of the energy storage system.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

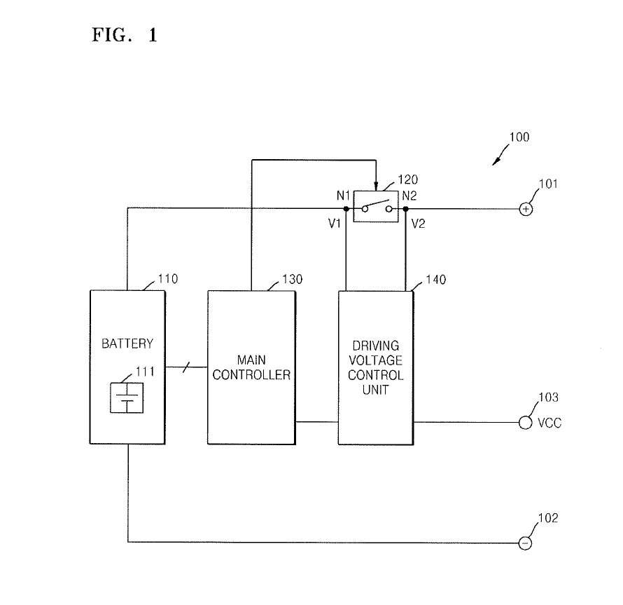

FIG. 1 illustrates an embodiment of a battery tray 100 that includes a battery 110, a main switch 120, a main controller 130, and a driving voltage control unit 140. The battery tray 100 includes a pair of tray terminals 101 and 102 including a first tray terminal 101 and a second tray terminal 102. The battery tray may also include a driving voltage terminal 103 to which a driving voltage Vcc for driving the main controller 130 and/or the driving voltage control unit 140 is applied.

The main switch 120 includes a first node N1 electrically connected to the battery 110 and a second node N2 electrically connected to one of tray terminals 101 and 102 (e.g., first tray terminal 101). The main controller 130 manages the battery 110 and controls the main switch 120. The driving voltage control unit 140 detects a battery voltage V1 of the first node Ni and a terminal voltage V2 of the second node N2, and controls driving of the main controller 130 based on the battery voltage V1 and the terminal voltage V2.

The battery 110 includes at least one battery cell 111. Although FIG. 1 shows that the battery 110 includes the one battery cell 111, the battery 110 may include a plurality of battery cells 111 connected to one another in series, in parallel, or a combination thereof The number and connection structure of the battery cells 111 may be determined, for example, based on output voltage and/or power storage capacity.

The battery cell 111 may include a rechargeable secondary battery. For example, battery cell 111 may include a nickel-cadmium battery, a lead storage battery, a nickel metal hydride (NiMH) battery, a lithium ion battery, a lithium polymer battery, etc.

The main switch 120 is controlled by the main controller 130 and is interconnected between the battery 110 and one of tray terminals 101 and 102 (e.g., the first tray terminal 101). The main switch 120 may be turned on by the main controller 130 and may be turned off when the main controller 130 is deactivated.

When the main switch 120 is turned on (i.e., when the main switch 120 is closed), the battery 110 and the first tray terminal 101 are electrically connected to each other. A charging device and/or a load may be electrically connected to the battery 110 via the tray terminals 101 and 102, where the battery 110 may be charged by the charging device or may discharge power to the load. When the main switch 120 is turned off (i.e., when the main switch 120 is opened), the battery 110 and the first tray terminal 101 are electrically insulated from each other. The main switch 120 may be interconnected between a negative electrode of the battery 110 and the second tray terminal 102. The main switch 120 may include a relay or a field effect transistor (FET).

The main controller 130 may manage the battery 110 and may control the main switch 120. The main controller 130 may detect cell voltage, temperature, and current of the battery 110 and may transmit information regarding the detected cell voltage, temperature, and current to an external device (e.g., a rack management unit). The main controller 130 may control the main switch 120 based on a control instruction from the external device. The main controller 130 may determine state of charge (SOC) or state of health (SOH) of the battery 110 or the battery cell 111 based on the detected cell voltage, temperature, and/or current. The main controller 130 may perform cell balancing with respect to the battery cells 111 of the battery 110 based on detected cell voltages.

The battery tray 100 may include a voltage sensor, a temperature sensor, and/or a current sensor for detecting cell voltage, temperature, and current of the battery 110. The main controller 130 may include, for example, a microcontroller unit and may be connected to the voltage sensor, the temperature sensor, and/or the current sensor.

When a driving voltage Vcc is applied to the main controller 130, the main controller 130 initiates operation and may turn on the main switch 120 according to a control signal received from an external device or an algorithm stored in the main controller 130. The driving voltage Vcc may be provided to the main controller 130 under the control of the driving voltage control unit 140.

The driving voltage control unit 140 detects a battery voltage V1 of the first node N1 between the main switch 120 and the battery 110, and a terminal voltage V2 of the second node N2 between the main switch 120 and the first tray terminal 101. The driving voltage control unit 140 controls driving of the main controller 130 based on the battery voltage V1 and the terminal voltage V2.

If a difference between the battery voltage V1 and the terminal voltage V2 is below or equal to a preset critical voltage, the driving voltage control unit 140 may control to apply the driving voltage Vcc to the main controller 130. The critical voltage may be a value which prevents generation of an in-rush current between the first node N1 and the second node N2 at a moment when the main switch 120 is switched from a turned-off state to a turned-on state.

According to one embodiment, the critical voltage may be a value from about 0.5V to about 2V. The critical voltage may be determined based on a nominal voltage of the battery 110. According to another embodiment, the critical voltage may be a value from about 0.5% to about 2% of the nominal voltage of the battery 110.

When a difference between the battery voltage V1 and the terminal voltage V2 exceeds the critical voltage, the driving voltage control unit 140 may not apply the driving voltage Vcc to the main controller 130. The main controller 130 is unable to initiate operation without the driving voltage Vcc, and thus the main controller 130 may be maintained in a turned-off state.

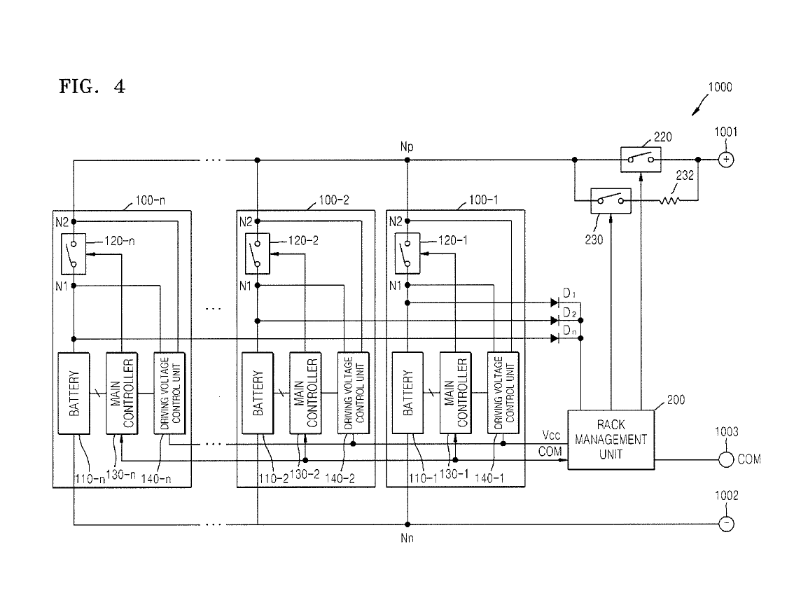

For a battery system including the battery tray 100 to have a large power storage capacity, a plurality of battery trays 100 may be connected to one another, in parallel, as illustrated in FIG. 4. To achieve this parallel connection, the first tray terminals 101 of the battery trays 100 may be electrically connected to one another, and the second tray terminals 102 of the battery trays 100 may be electrically connected to one another. For example, a first battery tray 100 and a second battery tray 100 may be connected to each other in parallel.

When a second main switch 120 of a second battery tray 100 is turned on, while a first main switch 120 of the first battery tray 100 is on, a first battery 110 of the first battery tray 100 and a second battery 110 of the second battery tray 100 are electrically connected to each other in parallel. If a voltage level of the first battery 110 is similar to a voltage level of the second battery 110, no in-rush current is generated when the second main switch 120 is turned on. However, if a voltage level of the first battery 110 is significantly different from a voltage level of the second battery 110, an in-rush current is generated when the second main switch 120 is turned on.

The first and second batteries 110 and/or first and second main switches 120 may be damaged by the in-rush current. Therefore, if a voltage level of the first battery 110 is significantly different from a voltage level of the second battery 110, the second main switch 120 is not turned on.

When the first main switch 120 of the first battery tray 100 is turned on, a battery voltage of the first battery 110 is applied to the first tray terminal 101 of the second battery tray 100. The battery voltage V1 of the first node N1 corresponds to a battery voltage of the second battery 110. The terminal voltage V2 of the second node N2 corresponds to a battery voltage of the first battery 110.

According to the present embodiment, the driving voltage control unit 140 controls operation of the main controller 130 based on the battery voltage V1 of the first node N1 and the terminal voltage V2 of the second node N2. Therefore, the driving voltage control unit 140 of the second battery tray 100 controls operation of the main controller 130 of the second battery tray 100 based on battery voltages of the second battery 110 and the first battery 110. If a battery voltage of the second battery 110 and a battery voltage of the first battery 110 are (or if a difference between these voltages is) out of a preset critical range, the driving voltage control unit 140 of the second battery tray 100 does not drive the main controller 130 of the second battery tray 100. Thus, main switch 120 of the second battery tray 100 is not turned on. Therefore, formation of an in-rush current may be prevented.

If the second battery tray 100 is deactivated, the main controller 130 may also be deactivated. Thus, unnecessary power consumption by the main controller 130 is prevented. Only a small amount of power is consumed by the driving voltage control unit 140. Therefore, power may be utilized efficiently.

Furthermore, if the main controller 130 is driven using power stored in the battery 110, the driving voltage control unit 140 consumes a small amount of power and, thus, the battery 110 is not over-discharged due to power consumed by the main controller 130. Therefore, a battery system including a plurality of battery trays connected to one another in parallel may operate stably.

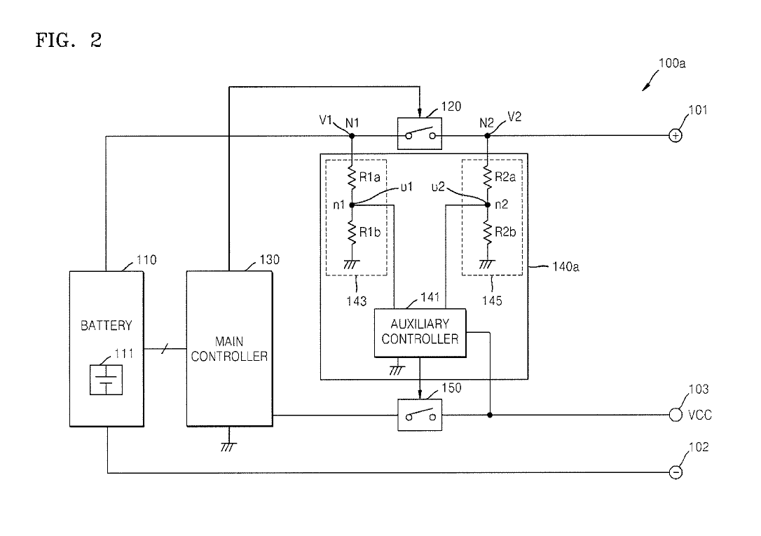

FIG. 2 illustrates another embodiment of a battery tray 100a that includes the battery 110, the main switch 120, the main controller 130, the driving voltage control unit 140a, and a driving voltage switch 150. Since the battery 110, the main switch 120, and the main controller 130 may respectively correspond to the battery 110, the main switch 120, and the main controller 130 of the battery tray 100 as shown in FIG. 1, detailed descriptions thereof will be omitted.

The driving voltage switch 150 is electrically connected between the driving voltage terminal 103 and the main controller 130, to which a driving voltage Vcc is applied, and is controlled by the driving voltage control unit 140a. The driving voltage switch 150 may include, for example, a transistor (e.g., FET) controlled by the driving voltage control unit 140a. When the driving voltage switch 150 is turned on, the driving voltage Vcc is supplied to the main controller 130. When the driving voltage switch 150 is turned off, the driving voltage Vcc is not supplied to the main controller 130. Thus, the main controller 130 is deactivated. The main switch 120 is turned off by the deactivated main controller 130.

The driving voltage control unit 140a detects a battery voltage V1 and a terminal voltage V2, and controls the driving voltage switch 150 based on the battery voltage V1 and the terminal voltage V2. The driving voltage control unit 140a may include an auxiliary controller 141, a battery voltage detecting unit 143, and a terminal voltage detecting unit 145.

The battery voltage detecting unit 143 detects a battery voltage V1 of the first node N1 between the battery 110 and the main switch 120, and generates a battery voltage signal v1 corresponding to the battery voltage V1.

The battery voltage detecting unit 143 may include a first voltage divider circuit connected between the first node N1 and ground. The first voltage divider circuit may include two resistors R1a and R1b. A node n1 between the resistor R1a and the resistor R1b has a voltage level proportional to the battery voltage V1, and the battery voltage signal v1 may be output from the node n1.

The terminal voltage detecting unit 145 detects a terminal voltage V2 between the first tray terminal 101 and the second node N2 of the main switch 120, and generates a terminal voltage signal v2 corresponding to the terminal voltage V2. The terminal voltage detecting unit 145 may include a second voltage divider circuit connected between the second node N2 and ground. The second voltage divider circuit may include two resistors R2a and R2b connected in series.

A node n2 between the resistor R2a and the resistor R2b has a voltage level proportional to the terminal voltage V2. The terminal voltage signal v2 may be output from the node n2. In one example embodiment, a ratio of the resistor R2a and the resistor R2b may be identical to a ratio of the resistor R1a and the resistor R1b. For example, a ratio of the resistor R2a and the resistor R2b may be 19:1. Also, a voltage level of the terminal voltage signal v2 may be one-twentieth of voltage level of the terminal voltage V2.

The auxiliary controller 141 receives the battery voltage signal v1 and the terminal voltage signal v2, and outputs a driving voltage control signal for controlling the driving voltage switch 150. The auxiliary controller 141 may include a microcontroller unit, and may include a first input terminal for receiving the battery voltage V1, a second input terminal for receiving the terminal voltage V2, and an output terminal for outputting the driving voltage control signal.

The auxiliary controller 141 may detect a voltage level of the battery voltage signal v1 received by the first input terminal. The auxiliary controller 141 may detect voltage level of the terminal voltage signal v2 received by the second input terminal. The auxiliary controller 141 may determine the battery voltage V1 based on the battery voltage signal v1, and may determine the terminal voltage V2 based on the terminal voltage signal v2. The output terminal of the auxiliary controller 141 may be connected to a control terminal of the driving voltage switch 150.

Because auxiliary controller 141 performs simple functions compared to the main controller 130, the auxiliary controller 141 may include a low-power microcontroller unit. Therefore, the auxiliary controller 141 may consume less power than the main controller 130. Furthermore, the auxiliary controller 141 may be driven by the driving voltage Vcc transmitted via the driving voltage terminal 103.

The auxiliary controller 141 may generate a driving voltage control signal for controlling the driving voltage switch 150 based on the battery voltage signal v1 and the terminal voltage signal v2. For example, the auxiliary controller 141 may generate a driving voltage control signal for turning on the driving voltage switch 150 when a difference between voltage level of the battery voltage signal v1 and voltage level of the terminal voltage signal v2 is less than or equal to a preset critical voltage.

The driving voltage switch 150 may be turned on in response to the driving voltage control signal, and may transmit the driving voltage Vcc to the main controller 130. The main controller 130 may receive the driving voltage Vcc. The main controller 130 may turn on the main switch 120 according to an algorithm stored in the main controller 130. As described above, because a difference between the battery voltage V1 and the terminal voltage V2 is not significant, no in-rush current is formed.

The auxiliary controller 141 may store data corresponding to the critical voltage.

The data may be modified by a user or an operator.

If a difference between voltage level of the battery voltage signal v1 and voltage level of the terminal voltage signal v2 is greater than the critical voltage, the auxiliary controller 141 may generate a driving voltage control signal for turning off the driving voltage switch 150. The driving voltage switch 150 maintains a turned-off state in response to the driving voltage control signal, and the main controller 130 which receives no driving voltage Vcc is deactivated. The main switch 120 is thus maintained in the turned-off state.

The main controller 130 may receive the driving voltage Vcc, via the auxiliary controller 141 and the driving voltage switch 150 controlled by the auxiliary controller 141, only if a difference between the battery voltage V1 and the terminal voltage V2 is small enough to not to form an in-rush current. Therefore, formation of an in-rush current may be prevented reliably.

If a difference between the battery voltage V1 and the terminal voltage V2 is significant, the main controller 130 is deactivated. Therefore, the main controller 130 consumes no power, and only the auxiliary controller 141, which consumes a small amount of power, operates. As a result, unnecessary power consumption may be reduced.

For a battery system including the battery tray 100a to have a large power storage capacity, a plurality of battery trays 100a may be connected in parallel as illustrated, for example, in FIG. 4. If all the main switches 120 of the battery trays 100a are turned off, all of the first tray terminals 101 of the battery trays 100 are in a floating state. When first tray terminals 101 are in a floating state, no in-rush current is formed, even if the main switches 120 are turned on.

The driving voltage control unit 140a may determine whether the first tray terminal 101 is in a floating state based on the terminal voltage V2. For example, the auxiliary controller 141 may determine whether the first tray terminal 101 is in a floating state based on a voltage level of the terminal voltage signal v2. For example, if the first tray terminal 101 is in a floating state, node n2 may have a ground voltage level due to the terminal voltage detecting unit 145 connected to ground. If voltage level of the terminal voltage signal v2 is substantially at ground voltage level, the auxiliary controller 141 may determine that the first tray terminal 101 is in a floating state.

When the first tray terminal 101 is determined to be in a floating state, driving voltage control unit 140a may turn on the driving voltage switch 150 regardless of the battery voltage V1 and the terminal voltage V2. As a result, the driving voltage Vcc may be applied to the main controller 130. The main controller 130 may initiate operation and turn on the main switch 120. If the main switch 120 of any of the battery trays 100a is turned on, the battery voltage V1 of the battery tray 100a having the turned-on main switch 120 is applied to the first tray terminal 101 of one or more of the other battery trays 100a. As a result, the first tray terminal 101 is no longer in a floating state.

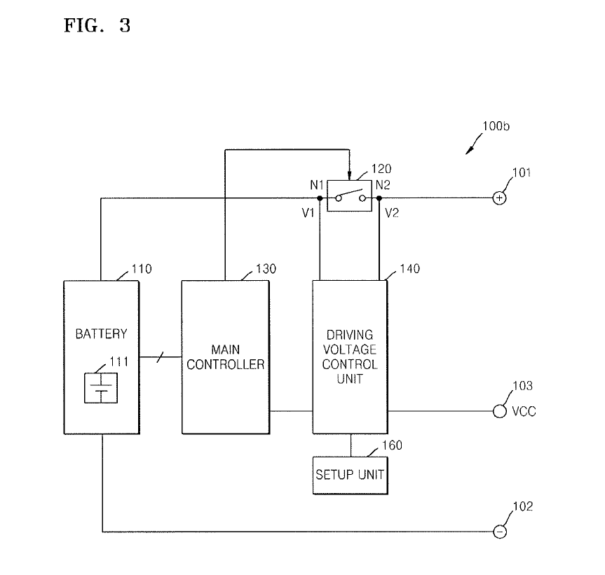

FIG. 3 illustrates another embodiment of a battery tray 100b that includes the battery 110, the main switch 120, the main controller 130, the driving voltage control unit 140, and a setup unit 160. Since the battery 110, the main switch 120, the main controller 130, and the driving voltage control unit 140 respectively correspond to the battery 110, the main switch 120, the main controller 130, and the driving voltage control unit 140 of the battery tray 100 may be the same as shown in FIG. 1, detailed descriptions thereof will be omitted.

Initially, it is set whether to deactivate the driving voltage control unit 140 via the setup unit 160. If the driving voltage control unit 140 is set to be deactivated via the setup unit 160, the main controller 130 may receive the driving voltage Vcc regardless of the battery voltage V1 and the terminal voltage V2. Deactivation of the driving voltage control unit 140 does not necessarily mean that the driving voltage control unit 140 is not operated, but rather means that the driving voltage Vcc is applied to the main controller 130 regardless of operation and function of the driving voltage control unit 140.

For example, if all the main switches 120 of the battery trays 100b connected in parallel as shown in FIG. 4 are turned off, all the first tray terminals 101 of the battery trays 100b are in a floating state. If the first tray terminals 101 are in a floating state, a difference between the battery voltage V1 and the terminal voltage V2 exceeds the critical voltage. As a result, main controller 130 is not driven by the driving voltage control unit 140. Therefore, the driving voltage control unit 140 may be deactivated in one or more of battery trays 100b. A user may deactivate the driving voltage control unit 140 of one or more of battery trays 100b via the setup unit 160. When the driving voltage control unit 140 is deactivated, the main controller 130 may receive the driving voltage Vcc regardless of the battery voltage V1 and the terminal voltage V2.

For example, the setup unit 160 may be a switch that may be set by a user.

When the switch is turned on, the driving voltage Vcc may be transmitted to the main controller 130 regardless of control of the driving voltage control unit 140. For example, the switch may be connected to the driving voltage switch shown in FIG. 2 in parallel.

In another example, the setup unit 160 may output a deactivation signal to the driving voltage control unit 140. In response to the deactivation signal, the driving voltage control unit 140 may apply the driving voltage Vcc to the main controller 130 regardless of the battery voltage V1 and the terminal voltage V2. For example, in the case of the battery tray 100a of FIG. 2, the auxiliary controller 141 may output a control signal for turning on the driving voltage switch 150 regardless of the battery voltage signal v1 and the terminal voltage signal v2 in response to the deactivation signal.

In another example, the setup unit 160 may include dip switches for setting ID numbers of the battery trays 100b. The main controllers 130 of the battery trays 100b, connected in parallel, may communicate with an external controller, e.g., the rack management unit 200 in FIG. 4. For the external controller to identify the main controllers 130 of the battery trays 100b, identification numbers (e.g., IDs) of the respective battery trays 100b may be included in a communication protocol. The identification numbers, for example, may be set by a user. The identification numbers may be set via the dip switches or via firmware. For example, if an identification number stored by the setup unit 160 is “1,” the driving voltage control unit 140 may transmit the driving voltage Vcc to the main controller 130 regardless of the battery voltage V1 and the terminal voltage V2.

FIG. 4 illustrates an embodiment of a battery rack 1000 that includes battery trays 100-1 through 100-n and a rack management unit 200. The battery trays 100-1 through 100-n are connected in parallel between a node Np and a node Nn. The battery trays 100-1 through 100-n include the battery trays 100-1 through 100-n, main switches 121-1 through 121-n, main controllers 130-1 through 130-n, and driving voltage control units 141-1 through 141-n, respectively.

Each of the batteries 110-1 through 110-n includes at least one battery cell. The main switches 120-1 through 120-n are electrically connected between battery trays 100-1 through 100-n and first tray terminals (101 of FIG. 1), respectively. The main controllers 130-1 through 130-n respectively manage the battery trays 100-1 through 100-n and control the main switches 121-1 through 121-n. The driving voltage control units 140-1 through 140-n are configured to detect battery voltages of the battery trays 100-1 through 100-n and a terminal voltage of the first tray terminal 101, and to control operations of the main controllers 130-1 through 130-n based on the battery voltages and the terminal voltage, respectively.

The battery trays 100-1 through 100-n may correspond to the battery tray 100 in

FIG. 1. In another example, the battery trays 100-1 through 100-n may correspond to any of the battery trays 100a and 100b shown in FIGS. 2 and 3. Since the battery trays 100-1 through 100-n are described above with reference to FIGS. 1 through 3, detailed descriptions thereof will be omitted.

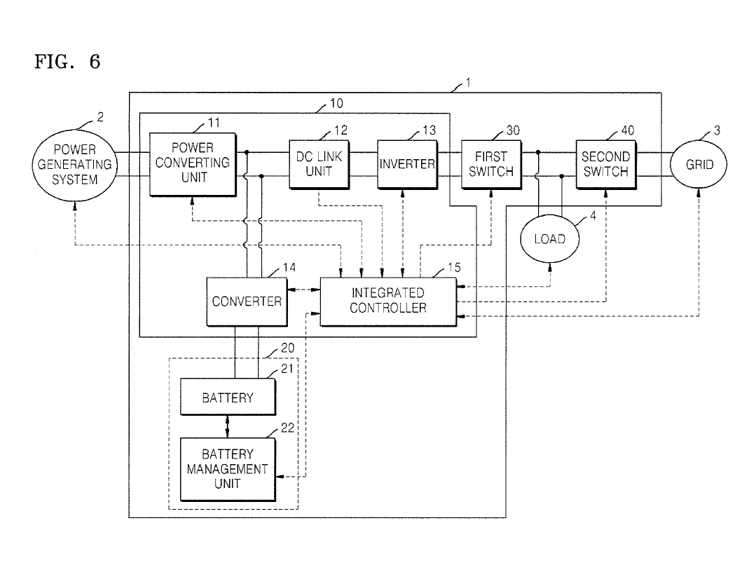

The battery rack 1000 includes a pair of rack terminals including a first rack terminal 1001 and a second rack terminal 1002. The rack terminals 1001 and 1002 may be connected to an external device such as a charger, a load, and a converter. The charger and/or the load may be connected to the rack terminals 1001 and 1002 via a converter (e.g., a converter 14 of FIG. 6). An example of the charger may be a power generating system 2 and/or a grid 3 as shown in FIG. 6, and an example of the load may be load 4 shown in FIG. 6. The battery rack 1000 may include a communication terminal 1003 for providing communications between the rack management unit 200 and an external device (e.g., an integrated controller 15 of FIG. 6).

The battery rack 1000 may include a charging path including a rack main switch 220 connected between the node Np to which the battery trays 100-1 through 100-n are connected and the first rack terminal 1001. The rack main switch 220 is a switch for controlling flow of current between batteries 110-1 through 110-n of the battery trays 100-1 through 100-n and the rack terminals 1001 and 1002. The rack main switch 220 may be controlled by the rack management unit 200. The rack main switch 220 may include a relay, for example. When the rack main switch 220 is turned on, current may flow via the charging path between the batteries 110-1 through 110-n of the battery trays 100-1 through 100-n and the rack terminals 1001 and 1002. For another example, the rack main switch 220 may be interposed between the node Nn and the second rack terminal 1002.

The battery rack 1000 may include a precharging path including a precharge switch 230 and a precharge resistor 232. The precharging path is connected to the charging path including the rack main switch 220 in parallel. The precharge switch 230 may be controlled by the rack management unit 200. The precharging path limits a charging current and a discharging current between the batteries 110-1 through 110-n of the battery trays 100-1 through 100-n and the rack terminals 1001 and 1002. When charging or discharging is initiated, an in-rush current may flow into or out of the batteries 110-1 through 110-n of the battery trays 100-1 through 100-n. By charging or discharging the batteries 110-1 through 110-n of the battery trays 100-1 through 100-n via the precharging path, while the charging path is opened at the early stage of charging or discharging, formation of an in-rush current may be prevented.

The rack management unit 200 manages the battery trays 100-1 through 100-n.

The rack management unit 200 may control the rack main switch 220 and the precharge switch 230. The rack management unit 200 may detect a rack voltage between the rack terminals 1001 and 1002 and a current on the charging path.

The rack management unit 200 may communicate with the main controllers 130-1 through 130-n of the battery trays 100-1 through 100-n, and may collect data including cell voltages, temperatures, and/or currents of the batteries 110-1 through 110-n from the main controllers 130-1 through 130-n. The rack management unit 200 may estimate states of charge (SOC) and states of health (SOH) of the batteries 110-1 through 110-n based on the collected data. The rack management unit 200 may transmit a control instruction to the main controllers 130-1 through 130-n.

A control area network (CAN) communication may be established between the rack management unit 200 and the main controllers 130-1 through 130-n, and the main controllers 130-1 through 130-n may have respective identification numbers (e.g., IDs) for communication. The rack management unit 200 may communicate with an external device via the communication terminal 1003. A CAN communication may be established between the rack management unit 200 and an external device, for example.

The rack management unit 200 may be connected to the batteries 110-1 through 110-n via diodes D1 through Dn. The rack management unit 200 may receive a driving voltage from the batteries 110-1 through 110-n. At least one of the batteries 110-1 through 110-n may function as a driving power supply of the rack management unit 200. The rack management unit 200 may supply the driving voltage Vcc to the main controllers 130-1 through 130-n via the driving voltage control units 141-1 through 141-n.

Each of the driving voltage control units 141-1 through 141-n detects a battery voltage of the first node N1 thereof and a terminal voltage of the second node N2 thereof, and may control operations of the main controllers 130-1 through 130-n based on the battery voltage of the first node N1 and the terminal voltage of the second node N2.

According to the embodiment shown in FIG. 2, the battery trays 100-1 through 100-n may further include driving voltage switches (150 of FIG. 2) electrically connected between driving voltage terminals (103 of FIG. 2) to which the driving voltage Vcc is applied from the rack management unit 200 and the main controllers 130-1 through 130-n, respectively. The driving voltage control units 141-1 through 141-n may control the driving voltage switches 150 based on the battery voltage of the first node N1 and the terminal voltage of the second node N2.

Each of the driving voltage control units 141-1 through 141-n may include a battery voltage detecting unit (143 of FIG. 2) which detects battery voltage of the first node N1 and outputs a battery voltage signal corresponding to the battery voltage, a terminal voltage detecting unit (145 of FIG. 2) which detects terminal voltage of the second node N2 and outputs a terminal voltage signal corresponding to the terminal voltage, and an auxiliary controller (141 of FIG. 2) which receives the battery voltage signal and the terminal voltage signal and outputs a driving voltage control signal for controlling the driving voltage switch 150.

For example, if a difference between a battery voltage of the first node N1 and a terminal voltage of the second node N2 is less than or equal to a preset critical voltage, the driving voltage control units 141-1 through 141-n may turn on the driving voltage switch 150 to apply the driving voltage Vcc supplied from the rack management unit 200 to the main controllers 130-1 through 130-n.

If a difference between a battery voltage of the first node N1 and a terminal voltage of the second node N2 is greater than the critical voltage, the driving voltage control units 141-1 through 141-n turns off driving voltage switch 150 so that the driving voltage Vcc will not be applied to main controllers 130-1 through 130-n.

If voltage level of a terminal voltage of second node N2 is substantially ground voltage level, one of driving voltage control units 141-1 through 141-n may turn on driving voltage switch 150 without considering battery voltage of first node Ni and the terminal voltage of second node N2, to apply driving voltage Vcc from rack management unit 200 to main controllers 130-1 through 130-n.

In FIG. 4, it is assumed that main switch 120-1 of the first battery tray 100-1 is turned off and all of the main switches 121-2 through 121-n of the other battery trays 100-2 through 100-n are turned on. The batteries 110-2 through 110-n of the battery trays 100-2 through 100-n are all connected in parallel, and battery voltages of the batteries 110-1 through 110-n are applied to the second node N2 of the first battery tray 100-1. In other words, terminal voltage of the second node N2 of the first battery tray 100-1 has a same voltage level as battery voltages of the batteries 110-2 through 110-n connected in parallel.

The driving voltage control unit 140-1 of the battery tray 100-1 controls operation of the main controller 130-1 based on battery voltage of the first node N1 and terminal voltage of the second node N2. Therefore, the driving voltage control unit 140-1 controls operation of the main controller 130-1 based on battery voltage of the battery 110-1 and battery voltages of the batteries 110-2 through 110-n connected in parallel.

For example, if a difference between battery voltage of the battery 110-1 and battery voltage of the batteries 110-2 through 110-n is less than or equal to a preset critical voltage, the driving voltage control unit 140-1 may turn on a driving voltage switch (150 of FIG. 2) of the first battery tray 100-1 to apply the driving voltage Vcc to the main controller 130-1.

If a difference between battery voltage of the battery 110-1 and battery voltage of the batteries 110-2 through 110-n is greater than the critical voltage, the driving voltage control unit 140-1 may turn off the driving voltage switch 150 of the first battery tray 100-1 to prevent driving voltage Vcc from being applied to the main controller 130-1.

In another example, one of the battery trays 100-1 through 100-n (e.g., the first battery tray 100-1) has an identification number for communication with the rack management unit 200. The identification number of the first battery tray 100-1 may be, e.g., “1”. The first driving voltage control unit 140-1 may be deactivated based on the identification number. For example, the first driving voltage control unit 140-1 may drive the main controller 130-1 regardless of battery voltage of the first node N1 and terminal voltage of the second node N2.

For another example, one of the battery trays 100-1 through 100-n (e.g., the first battery tray 100-1) may not include the driving voltage control unit 140-1. The driving voltage Vcc supplied from the rack management unit 200 may be applied to the main controller 130-1.

In the battery rack 1000 according to the present embodiment, the main switches 121-1 through 121-n of the battery trays 100-1 through 100-n may be turned on under a condition in which no in-rush current is formed. Formation of an in-rush current may therefore be prevented and the battery rack 1000 may be operated stably and reliably.

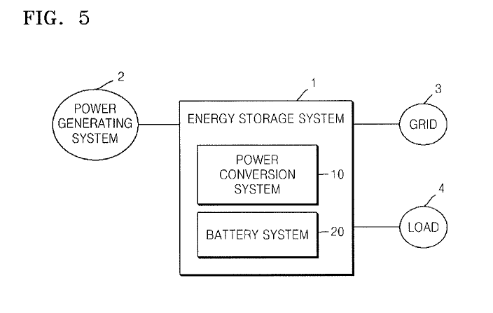

FIG. 5 illustrates an embodiment of an energy storage system 1 and a peripheral configuration according to one embodiment. Referring to FIG. 5, the energy storage system 1 may operate with a power generating system 2, a grid 3, and a load 4. In operation, the energy storage system 1 receives and stores power from the power generating system 2 and/or the grid 3, and supplies stored power to the load 4.

The energy storage system 1 includes a battery system 20 for storing power and a power conversion system (PCS) 10. The battery system 20 includes the battery rack 1000, for example, as shown in FIG. 4. The battery system 20 may include a plurality of battery racks 1000 connected in parallel, in series, or a combination thereof.

The PCS 10 may convert power between the power generating system 2, the grid 3, the load 4, and the battery system 20. The PCS 10 may convert power supplied from the power generating system 2, the grid 3, and/or the load 4 into power of a suitable form for supply to the battery system 20 and/or the grid 3.

The power generating system 2 generates power from an energy source. For example, the power generating system 2 may include at least one of a solar power generating system, a wind power generating system, and a tidal power generating system. A large-capacity energy system may be configured by arranging a plurality of power generating systems 2 capable of producing power. Power generated by the power generating system 2 may be supplied to the energy storage system 1. The energy storage system 1 may store power generated by the power generating system 2 in the battery system 20 or supply the power to the grid 3.

The grid 3 may include a power plant, a substation, and/or a power line. If the grid 3 is normal, the grid 3 may supply power to the load 4 and/or the battery system 20, or may receive power from the battery system 20 and/or the power generating system 2. For example, the energy storage system 1 may supply power stored in the battery system 20 to the grid 3, or may store power supplied from the grid 3 in the battery system 20. If the grid 3 is not normal (e.g., if there is a power interruption), power transmission between the grid 3 and the energy storage system 1 is stopped. The energy storage system 1 may perform an uninterrupted power supply (UPS) function and supply power generated by the power generating system 2 or power stored in the battery system 20 to the load 4.

The load 4 may consume power generated by the power generating system 2, power stored in the battery system 20, and/or power supplied from the grid 3. Examples of load 4 include electric devices at households or factories in which the energy storage systems 1 are installed.

FIG. 6 illustrates a more detailed configuration of the energy storage system 1 which includes the PCS 10, the battery system 20, a first switch 30, and a second switch 40. The battery system 20 may include a battery 21 and a battery management unit 22.

The PCS 10 may convert power between the power generating system 2, the grid 3, the load 4, and the battery system 20. The PCS 10 may convert power supplied from the power generating system 2 into power of a suitable form for supply to the load 4, the battery system 20, and/or the grid 3. The PCS 10 may convert power supplied from the battery system 20 into power of a suitable form for supply to the load 4 and/or the grid 3. The PCS 10 may include a power converting unit 11, a DC link unit 12, an inverter 13, a converter 14, and an integrated controller 15. The power converting unit 11 may be a power conversion unit connected between power generating system 2 and DC link unit 12. The power converting unit 11 may convert power generated by power generating system 2 to a DC link voltage for transmission to DC link unit 12. The power converting unit 11 may include one or more power conversion circuits, such as a converter circuit and/or rectification circuit, based on the type of power generating system 2.

If power generating system 2 generates DC power, the power converting unit 11 may include a DC-DC converter circuit for converting DC power generated by the power generating system 2 into DC power suitable for the DC link unit 12. If the power generating system 2 generates AC power, the power converting unit 11 may include a rectification circuit for converting AC power generated by the power generating system 2 into DC power suitable for the DC link unit 12.

If the power generating system 2 is a solar power generating system, the power converting unit 11 may include a maximum power point tracking (MPPT) converter. The MPPT converter performs MPPT control for obtaining maximum power generated by the power generating system 2 based on changes in insolation and temperature. When no power is generated by the power generating system 2, operation of the power converting unit 11 is stopped, and thus consumed power may be reduced.

Although a DC link voltage may be stabilized for normal operations of the converter 14 and the inverter 13, size of the DC link voltage may become unstable due to problems, including a momentary voltage drop at the power generating system 2 or the grid 3 or a peak load at the load 4. The DC link unit 12 is connected between the power converting unit 11, the inverter 13, and the converter 14 and may substantially stabilize a DC link voltage. The DC link unit 12 may include, for example, a large-capacity capacitor.

The inverter 13 is a power conversion unit connected between the DC link unit 12 and the first switch 30. The inverter 13 may include an inverter for converting a DC link voltage of the DC link unit 12 into an AC voltage, and for outputting the AC voltage. An AC voltage output by the inverter 13 may be supplied to the load 4 and/or the grid 3. Furthermore, the inverter 13 may include a rectification circuit for converting an AC voltage supplied from the grid 3 into a DC link voltage, and for outputting the DC link voltage to the DC link unit 12. A DC link voltage output by the inverter 13 may be supplied to the battery system 20 in charging mode. The inverter 13 may be a bidirectional inverter having input and output directions are changeable.

The inverter 13 may include a filter for removing harmonics from an AC voltage supplied to the grid 3. The inverter 13 may include a phase-locked loop (PLL) circuit for synchronizing phase of an AC voltage output from the inverter 13 with phase of an AC voltage of the grid 3, to suppress or limit formation of a reactive power. The inverter 13 may perform functions including limiting a voltage fluctuation range, enhancing a power factor, removal of DC components, and protection or reduction of transient phenomena, etc.

The converter 14 is a power conversion unit connected between the DC link unit 12 and the battery system 20. The converter 14 may include a DC-DC converter for converting power stored in the battery system 20 into a DC link voltage for output to DC link unit 12 in discharging mode. The converter 14 includes a DC-DC converter for DC-DC converting a DC link voltage of the DC link unit 12 into a charging voltage level of the battery system 20 and outputs the. The DC link voltage is output to the battery system 20. The converter 14 may be a bidirectional converter whose input and output directions are changeable. If the battery system 20 is neither charged nor discharged, operation of the converter 14 is stopped and, thus, power consumption may be reduced.

The integrated controller 15 may monitor the status of the power generating system 2, the grid 3, the battery system 20, and/or the load 4. For example, the integrated controller 15 may monitor whether there is a power interruption at the grid 3, whether power is generated by the power generating system 2, an amount of power generated by the power generating system 2, charging status of the battery system 20, and/or an amount of power consumed by the load 4.

The integrated controller 15 may control operations of the power converting unit 11, the inverter 13, the converter 14, the battery system 20, the first switch 30, and the second switch 40 based on monitoring results and a pre-set algorithm. For example, if there is a power interruption at the grid 3, the integrated controller 15 may supply power stored in the battery system 20 or power generated by the power generating system 2 to the load 4. If sufficient power may not be supplied to the load 4, the integrated controller 15 may set priorities regarding electric devices of the load 4 and/or may perform a control operation to supply power to one or more of the electric devices of the load 4 with higher priorities. The integrated controller 15 may control charging and discharging of the battery system 20.

The first switch 30 and the second switch 40 are connected in series between the inverter 13 and the grid 3, and are turned on and off by the integrated controller 15 to control flow of current between or among the DC link unit 12, the grid 3, and the load 4. Based on the status of the power generating system 2, the grid 3, and the battery system 20, the first switch 30 and the second switch 40 may be turned on or off. For example, if power from the power generating system 2 and/or the battery system 20 is supplied to the load 4, or power from the grid 3 is supplied to the battery system 20, the first switch 30 may be turned on. If power from the power generating system 2 and/or the battery system 20 is supplied to the grid 3, or power from the grid 3 is supplied to the load 4 and/or the battery system 20, the second switch 40 turned on.

If there is a power interruption at the grid 3, the second switch 40 is turned off and the first switch 30 is turned on. Therefore, power from the power generating system 2 and/or the battery system 20 is supplied to the load 4, and power to be supplied to the load 4 is prevented from being directed toward the grid 3.

As described above, by operating the energy storage system 1 as a standalone system, an accident that involves a worker working on a power line of the grid 3 being electrocuted by power from the power generating system 2 and/or the battery system 20 may be prevented.

The first switch 30 and the second switch 40 may include a switching device capable of withstanding a large current or handling a large current, such as a relay.

The battery system 20 may receive and store power from the power generating system 2 and/or the grid 3, and may supply stored power to the load 4 and/or the grid 3. The battery system 20 may include the battery rack 1000 as set forth in FIG. 4. The battery system 20 may include at least one of battery trays 100, 100a, and 100b as described above with reference to FIGS. 1 through 3.

To store power, the battery system 20 may include the battery 21 having at least one battery cell and the battery management unit 22 for controlling and protecting the battery 21. The battery management unit 22 is connected to the battery 21 and may control overall operations of the battery system 20 according to control instructions from the integrated controller 15 and/or an internal algorithm. For example, the battery management unit 22 may perform functions which include one or more of overcharge prevention, over-discharge prevention, over-current prevention, over-voltage prevention, overheat prevention, and cell balancing.

The battery management unit 22 may obtain a voltage, a current, a temperature, remaining power, lifespan, and/or state of charge (SOC) regarding the battery 21. For example, the battery management unit 22 may measure cell voltage, current, and/or temperature of the battery 21. To detect temperature of the battery 21, at least one temperature sensor may be arranged in the battery 21. Based on a measured cell voltage, current, and/or temperature, the battery management unit 22 may calculate remaining power, lifespan, and/or SOC of the battery 21. The battery management unit 22 may mange the battery 21 based on results of measurements and calculations and may transmit the results to the integrated controller 15. The battery management unit 22 may control charging operation or discharging operation of the battery 21 based on a charge control instruction or a discharge control instruction received from the integrated controller 15.

The battery 21 may correspond to the battery 110 of FIGS. 1 through 3 and the batteries 110-1 through 110-n of FIG. 4. The battery management unit 22 may correspond to the main controller 130 and the driving voltage control unit 140 of FIGS. 1 through 3 and the rack management unit 200 of FIG. 4.

By way of summation and review, one approach for increasing capacity involves connecting battery trays in parallel. If voltages of the battery trays are different, an in-rush current is formed when the trays are connected. The in-rush current may damage the battery cells in the trays and their attendant protection circuits.

In accordance with one or more of the aforementioned embodiments, a main switch inside a battery tray is controlled based on a battery voltage and a terminal voltage. Therefore, battery trays of a battery system may be connected to each other in a stable manner without formation of an in-rush current. Accordingly, even if battery trays are connected in parallel, formation of an in-rush current may be prevented. Because battery cells or internal elements are prevented from being damaged by in-rush current, lifespan of a battery system may be extended and the battery system may be operated stably and reliably.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A battery tray, comprising:
a pair of tray terminals including a first tray terminal;
a battery including at least one battery cell;
a main switch including a first node electrically connected to the battery and a second node electrically connected to the first tray terminal;
a main controller to manage the battery and control the main switch; and
a driving voltage control unit to detect a battery voltage of the first node and terminal voltage of the second node, and to control operation of the main controller based on the battery voltage and the terminal voltage.

2. The battery tray as claimed in claim 1, further comprising:
a driving voltage switch; electrically connected between a driving voltage terminal to which a driving voltage is applied and the main controller, wherein the driving voltage control unit is to control the driving voltage switch based on the battery voltage and the terminal voltage.

3. The battery tray as claimed in claim 2, wherein the driving voltage control unit includes:
a battery voltage detecting unit to detect the battery voltage and to output a battery voltage signal corresponding to the battery voltage;
a terminal voltage detecting unit to detect the terminal voltage and to output a terminal voltage signal corresponding to the terminal voltage; and
an auxiliary controller to receive the battery voltage signal and the terminal voltage signal, and to output a driving voltage control signal for controlling the driving voltage switch.

4. The battery tray as claimed in claim 3, wherein the battery voltage detecting unit includes:
a first voltage divider circuit which is electrically connected to the first node and which outputs the battery voltage signal, and
the terminal voltage detecting unit including a second voltage divider circuit which is electrically connected to the second node and which outputs the terminal voltage signal.

5. The battery tray as claimed in claim 3, wherein the auxiliary controller consumes less power than the main controller.

6. The battery tray as claimed in claim 3, wherein the auxiliary controller is driven based on the driving voltage.

7. The battery tray as claimed in claim 2, wherein the driving voltage control unit is to turn on the driving voltage switch to apply the driving voltage to the main controller, when a difference between the battery voltage and terminal voltage is less than or equal to a preset critical voltage.

8. The battery tray as claimed in claim 7, wherein the critical voltage is a value between 0.5V and 2V or a value between 0.5% to 2% of the battery voltage.

9. The battery tray as claimed in claim 2, wherein:
the driving voltage control unit is to determine whether the first tray terminal is in a floating state, and
when the first tray terminal is determined to be in a floating state, the driving voltage control unit is to turn on the driving voltage switch to apply the driving voltage to the main controller, regardless of the battery voltage and the terminal voltage.

10. The battery tray as claimed in claim 1, further comprising:
a setup unit to set deactivation of the driving voltage control unit,
wherein, when the driving voltage control unit is set to be deactivated by the setup unit, the main controller is to receive the driving voltage regardless of the battery voltage and the terminal voltage.

11. A battery rack, comprising:
a plurality of battery trays connected in parallel; and
a rack management unit to manage the plurality of battery trays,
wherein each of the battery trays includes:
a pair of tray terminals including a first tray terminal;
a battery including at least one battery cell;
a main switch including a first node electrically connected to the battery and a second node electrically connected to the first tray terminal;
a main controller to manage the battery and control the main switch; and
a driving voltage control unit to detect a battery voltage of the first node and a terminal voltage of the second node, and to control operation of the main controller based on the battery voltage and the terminal voltage.

12. The battery rack as claimed in claim 11, wherein at least one of the batteries of the plurality of battery trays serves as a driving power supply of the rack management unit.

13. The battery rack as claimed in claim 11, wherein each of the battery trays includes a driving voltage switch electrically connected between a driving voltage terminal to which a driving voltage is applied and the main controller, wherein the driving voltage control unit is to control the driving voltage switch based on the battery voltage and the terminal voltage.

14. The battery rack as claimed in claim 13, wherein:
the driving voltage control unit is to turn on the driving voltage switch to apply the driving voltage to the main controller when a difference between the battery voltage and terminal voltage is less than or equal to a preset critical voltage, and
the driving voltage control unit is to turn off the driving voltage switch to prevent the driving voltage from being applied to the main controller when a difference between the battery voltage and terminal voltage is greater than the preset critical voltage.

15. The battery rack as claimed in claim 14, wherein:
the battery trays include a first battery tray having a turned-on main switch and a second battery tray having a turned-off main switch,
when a difference between battery voltage of the first battery tray and the battery voltage of the second battery tray is less than or equal to the critical voltage, the driving voltage control unit of the second battery tray is to turn on the driving voltage switch of the second battery tray to apply the driving voltage to the main controller of the second battery tray, and
when the difference between battery voltage of the first battery tray and battery voltage of the second battery tray is greater than the critical voltage, the driving voltage control unit of the second battery tray is to turn on the driving voltage switch of the second battery tray to apply the driving voltage to the main controller of the second battery tray.

16. The battery rack as claimed in claim 13, wherein the driving voltage control unit includes:
a battery voltage detecting unit to detect the battery voltage and to output a battery voltage signal corresponding to the battery voltage;
a terminal voltage detecting unit to detect the terminal voltage and to output a terminal voltage signal corresponding to the terminal voltage; and
an auxiliary controller to receive the battery voltage signal and the terminal voltage signal and to output a driving voltage control signal for controlling the driving voltage switch.

17. An energy storage system, comprising:
a battery system including a battery rack as claimed in claim 11; and
a power conversion system including:
a power conversion apparatus to convert power between or among at least two of a power generating system, a grid, a load, or the battery system, and
an integrated controller to control the power conversion apparatus.

18. A method of operating a battery tray, the method comprising:
detecting a first voltage of a first node of a main switch via a driving voltage control unit;
detecting a second voltage of a second node of the main switch via the driving voltage control unit; and
driving a main controller based on the first voltage and the second voltage via the driving voltage control unit.

19. The method as claimed in claim 18, wherein driving the main controller includes:
comparing a difference between the first voltage and second voltage to a preset critical voltage;
when the difference is less than or equal to the critical voltage, driving the main controller; and
when the difference is greater than the critical voltage, preventing driving of the main controller.

20. The method as claimed in claim 18, wherein:
the battery tray includes a driving voltage switch to provide a driving voltage to the main controller, and
driving the main controller includes controlling the driving voltage switch based on the first voltage and the second voltage via the driving voltage control unit.
